(19) United States
(12) Patent Application Publication
(10) Pub. No.: US 2007/0068083 A1
(43) Pub. Date: Mar. 29, 2007

(54) Auxiliary device of movable plank

(76) Inventor: Su-Mei Huang, Yunlin County (TW)

Correspondence Address: BACON & THOMAS, PLLC, 625 SLATERS LANE, FOURTH FLOOR, ALEXANDRIA, VA, 22314, US

(21) Appl. No.: 11/524,921

(22) Filed: Sep. 22, 2006

(30) Foreign Application Priority Data
Sep. 27, 2005 (TW) 94133612

(51) Int. Cl. E06B 11/00

(52) U.S. Cl. 49/381

(57) ABSTRACT

An auxiliary device of a movable plank, wherein the movable plank is moved between a first position and a second position, includes a sliding member, a driving member and a power providing device. The sliding member is provided adjacent to the frame and incident to a screw pair. The driving member is provided adjacent to the sliding and incident to a screw pair. The power providing device is provided adjacent to the sliding member. The power providing device stores power when the movable plank is moved to the first position, and releases the power to move the sliding member when the movable plank is moved to the second position from the first position.

### BACKGROUND OF THE INVENTION

1. Field of the Invention

The present invention relates generally to a movable plank, like door or lid which is hinged for closing and opening, and more particularly to an auxiliary device of a movable plank to return the movable plank when it is opened and to provide an auxiliary force to help user open it.

2. Description of the Related Art

In some places, heavy doors are provided for the entrance. The heavy door may prevent user from opening the door unexpectedly by impact or swing. On the contrary, the heavy door also makes the user hard to open or close it.

For the doors mounted on the decks of ships, the doors are hinged on the deck and even with the deck. The doors are very heavy to prevent them from opening by the swing of ship. A person in the ship who likes to go to the deck via the door has to exert the door with greater strength to open it up. Sometime, it hurts people when people opens or close the door. The same condition occurs in tanks. The doors of tanks are heavy as well that has the same problem.

Some doors are provided with torsional springs on the hinges to return the door automatically when it is opened. However, the stress is concentrated at opposite ends of the torsional spring that makes the spring damage. Furthermore, the spring force on the door will impact the door on the wall.

### SUMMARY OF THE INVENTION

The primary objective of the present invention is to provide an auxiliary device of a movable plank, which may help user to move the movable plank with less strength.

The secondary objective of the present invention is to provide an auxiliary device of a movable plank, which may return the movable plank automatically.

According to the objectives of the present invention, an auxiliary device of a movable plank, wherein the movable plank is moved between a first position and a second position, and the device is mounted between the movable plank and a frame, includes a sliding member adjacent to the frame and incident to a screw pair, a driving member adjacent to the sliding and incident to a screw pair; and a power providing device adjacent to the sliding member. The power providing device stores power when the movable plank is moved to the first position, and releases the power to move the sliding member when the movable plank is moved to the second position from the first position.

### BRIEF DESCRIPTION OF THE DRAWINGS

FIG. 1 is a top view of a first preferred embodiment of the present invention, showing the movable plank in the close position;

FIG. 2 is an exploded view of the sliding member and the fixed base;

FIG. 3 is a sectional view of the first preferred embodiment of the present invention, showing the movable plank in the close position;

FIG. 4 is similar to FIG. 1, showing the movable plank in the open position;

FIG. 5 is similar to FIG. 5, showing the movable plank in the open position;

FIG. 6 is similar to FIG. 1, showing the sliding member and the positioning ring;

FIG. 7 is a sketch diagram of a second preferred embodiment of the present invention; and

FIG. 8 is a sketch diagram of a third preferred embodiment of the present invention.

### DETAILED DESCRIPTION OF THE INVENTION

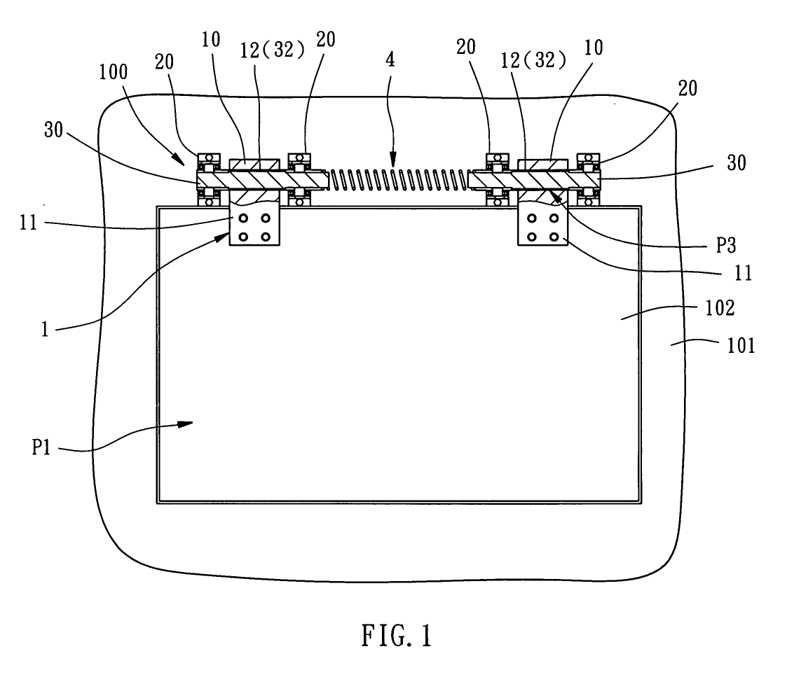

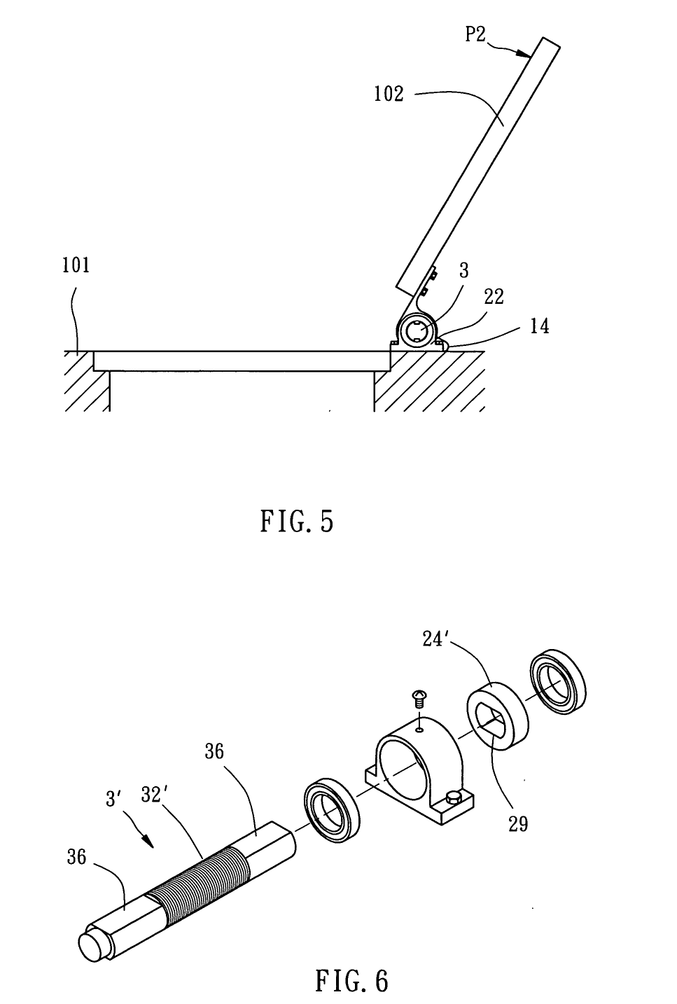

As shown in FIG. 1 to FIG. 3, an auxiliary device 100 of the first preferred embodiment of the present invention is mounted between a movable plank 102 and a frame 2. The movable plank 102 may be moved between a first position P1 (the close position, FIG. 3) and a second position P2 (the open position, FIG. 5). The frame 2 includes a fixed object 101 and four fixed bases 20. The fixed object 101 may be the deck of ship, armor of tank or building. Ship for example, the movable plank 102 may be isolation of cabin, and tank for example, the movable plank 102 may be isolation of the room in the tank, and building, the movable plank 102 may be door of entrance. The same feature of the movable plank 102 is that the movable plank 102 has a side pivoted on the fixed object 101, such that the movable plank 102 may be swung relative to the fixed object 101 between the first position P1 and the second position P2.

The device 100 of the present invention includes two driving member 1, two sliding member 3 and a power providing device. In the present embodiment, the power providing device is a compression spring. The detail of the device 100 and the frame 2 are described hereafter.

Each of the driving members 1 is a rigid body having an extending portion 10 and a fixed portion 11. The fixed portion 11 is fixed to the movable plank 102, and the extending portions 10 is located at a side associated with the movable plank 102. Each of the extending portions 10 includes a threaded hole 12. In the present embodiment, the driving members 1 are fixed to the movable plank independently. The extending portions may be parts of the movable plank also. In addition, each of the driving members 1 has a positioning portion 14 at a distal end of each of the extending portions 10, as shown in FIG. 3.

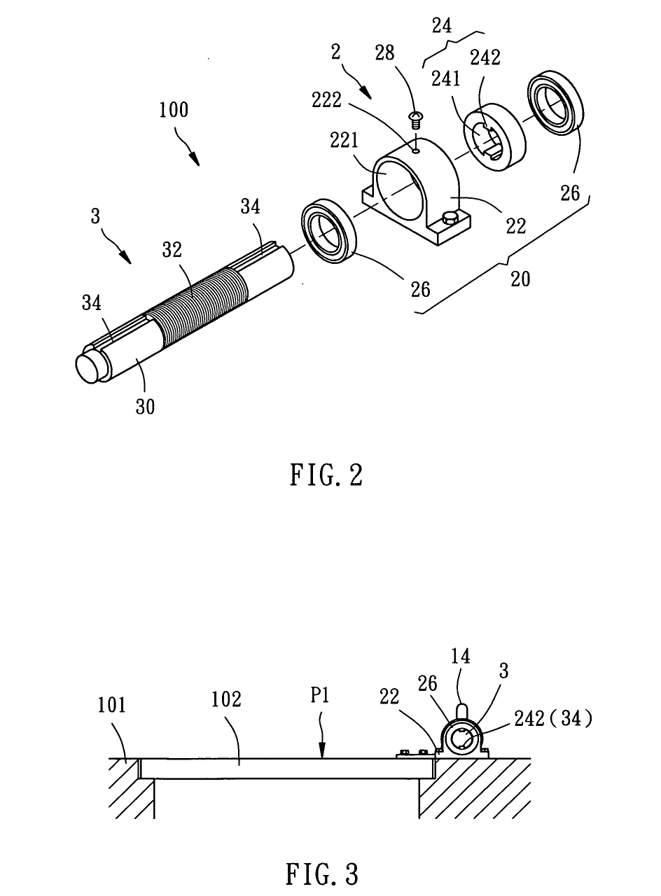

We will not discuss the fixed object 101 of the frame 2. The four fixed bases 20 are divided into two pairs at opposite sides of the driving members 1 respectively, as shown in FIG. 1. FIG. 2 shows the fixed base 20 including a base member 22, a positioning ring 24 and two bearings 26. The base member 22, which includes an axial hole 221 and a through hole 222, is fixed on the fixed object 101. The positioning ring 24, which includes a through aperture 241 and two contacting portions (keys) 242 on a wall of the through aperture 241, is inserted into the axial hole 221. A fixing member 28 has an end inserted into the through hole 222 and against the positioning ring 24 to prevent the positioning ring 24 from rotation. The bearings 26 are fitted to the opposite sides of the positioning ring 24 and located in the axial hole 221.

Each of the sliding members 3 has a round pole 20 with a threaded section 32 and four restricting portions (key slots) 34. As shown in FIG. 2, the threaded section 32 is on a middle of a circumference of the round pole 20, and the key slots 34 are divided into two pairs at opposite sides of the threaded section 32. The sliding members 3 are located between the extending portions 10 of the driving member 1 and fixed bases 20 of the frame 2. In other words, the threaded sections 32 of the sliding members 3 are meshed with the threaded holes 12 of the extending portions 10 respectively, and the key slots 34 of the sliding member 3 are fitted to the keys 242 of the fixed bases 20 respectively to prevent the sliding members from rotation. Except for the engagement of keys 242 and the key slots 34, it also may provide planes 36 at opposite sides of the threaded section 32′ of the sliding member 3′ and planes 29 at an interior wall of the positioning ring 24′, as shown in FIG. 6, to prevent the sliding members from rotation. Any equivalent device or structure that may achieve the function of preventing the sliding members from rotation will be within the scope of the present invention.

The compression spring 4 has opposite ends biasing ends of the round poles 30 of the sliding members 3 respectively to exert the sliding members 3 outwardly.

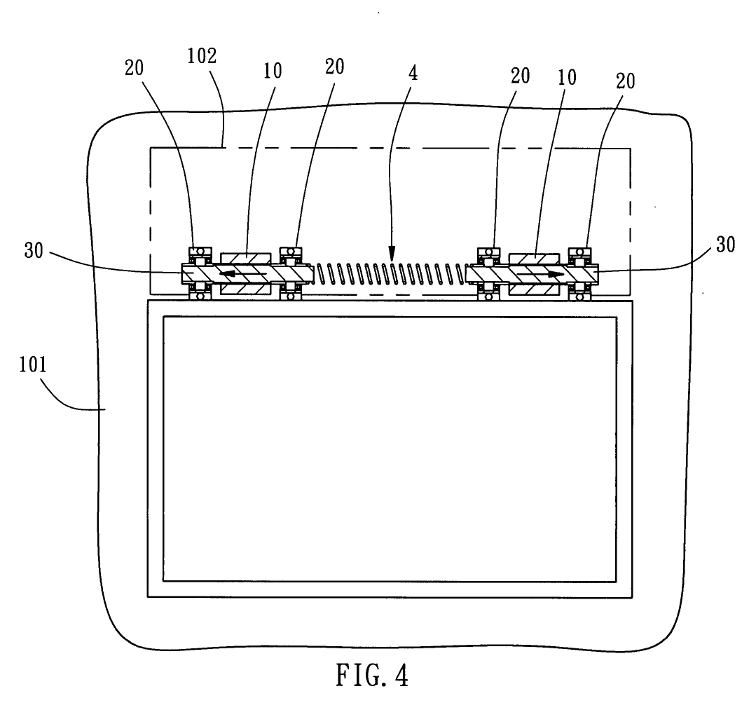

As shown in FIG. 1 and FIG. 3, the movable plank 102 is located at the first position P1 (the close position), in which a distance between the sliding members 3 is less and the sliding members 3 are compressing the compression spring 4. When the movable plank 102 is moved to the second position P2 (the open position) to the first position P1, the sliding members 3 will be rotating along an axial direction of the round poles 20 and moving outwardly because of the fitness of the threaded hole 12 and the threaded section 32. As a result, by the engagement of the key slots 34 of the sliding members 3 and the keys 242, the rotation of the sliding members 3 will rotate the movable plate 102 to the second position P2, as shown in FIG. 4 and FIG. 5. At the second position P2, a distance between the sliding members 3 is greater. The positioning portions 14 may stop the movable plank 102 at the second position P2 because that the positioning portions 14 touch the fixed object 101 when the movable plank 102 is moved to the second position P2. At the second position P2, an angle of the movable plate 102 is greater than ninety degrees that facilitate user to move the movable plate 102.

The power providing device may be a tension spring and the moving directions of the sliding members are designated opposite to the above description. Except for the compression spring and tension spring, the power providing device may be Belleville spring, leaf spring, rubber spring and the other relative devices.

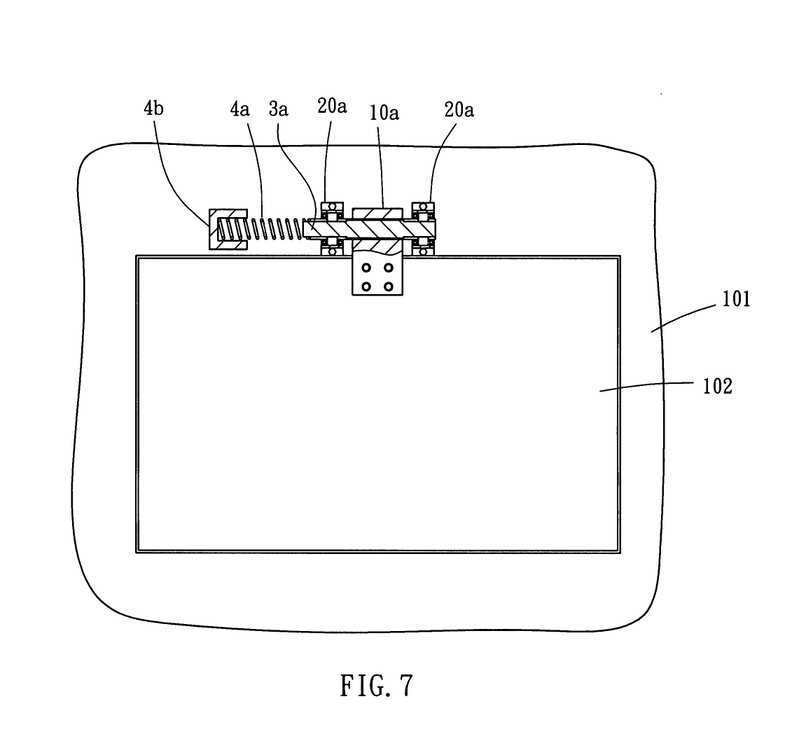

FIG. 7 shows a device having an extending portion 10a, a fixed base 20a, a sliding member 3a and a spring 4a for a lighter movable plank. The spring may have various types like above description. When the movable plank is a door, the first position is the close condition of the door and the second position is the open condition of the door. The lighter door has no problem to open it, but it has to aware of the closing speed of the door. The sliding members 3 of the present invention have the function of slowing down the speed when the door is closing.

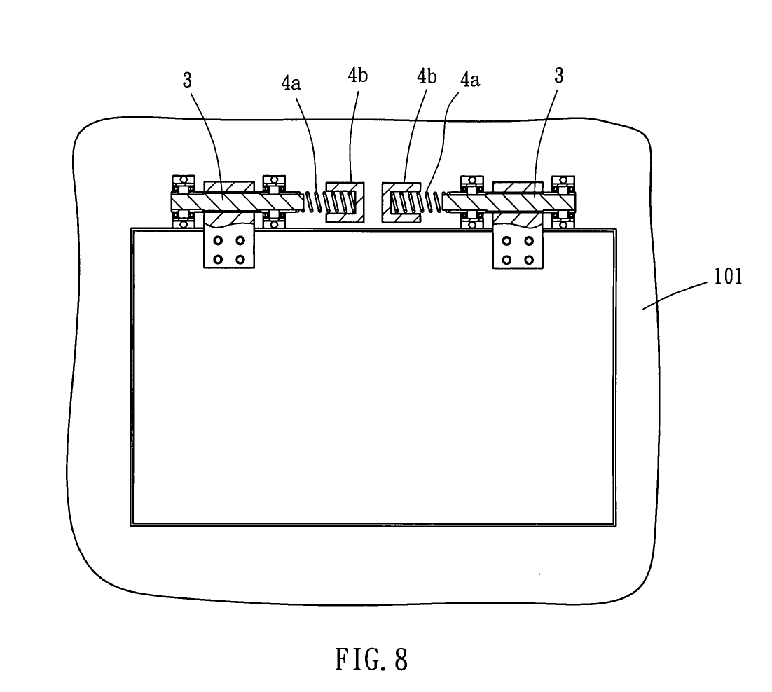

FIG. 8 shows a device of the present invention mounted on a plank of greater size. The fixed object 101 is provided with two stop walls 4b, and the device is provided with two springs 4a urging the stop walls 4b respectively. The single spring has a longer length that causes hard to assemble the spring.

The description above is a few preferred embodiments of the present invention and the equivalence of the present invention is still in the scope of the claim of the present invention.

What is claimed is:

1. An auxiliary device of a movable plank, wherein the movable plank is moved between a first position and a second position, and the device is mounted between the movable plank and a frame, comprising:
a sliding member adjacent to the frame and incident to a sliding pair;
a driving member adjacent to the sliding member and incident to a screw pair; and
a power providing device adjacent to the sliding member, wherein the power providing device stores power when the movable plank is moved to the first position, and releases the power to move the sliding member when the movable plank is moved to the second position from the first position.

2. The auxiliary device as defined in claim 1, wherein the driving member includes a threaded hole, and the sliding member has a threaded section meshed with the threaded hole.

3. The auxiliary device as defined in claim 2, wherein the sliding member has at least a restricting portion beside the threaded section, and the frame includes a through aperture and a contacting portion, which an end of the sliding member is inserted into the through aperture, and the restricting portion is engaged with the contacting portion to prevent the sliding member from rotation.

4. The auxiliary device as defined in claim 3, wherein the frame includes a fixed object and at least a fixed base, on which the through aperture and the contacting portion are provided, fixed to the fixed object.

5. The auxiliary device as defined in claim 1, wherein the driving member is provided with a positioning position to contact the frame when the movable plank is moved to the first position.

6. The auxiliary device as defined in claim 1, wherein the power providing device is an elastic member that may be return to an initial condition thereof when it is exerted.
